(19) United States
(12) Patent Application Publication
(10) Pub. No.: US 2017/0321861 A1
(43) Pub. Date: Nov. 9, 2017

(54) LIGHTING MODULE COMPRISING MOVABLE MIRRORS

(71) Applicant: VALEO VISION, Bobigny Cedex (FR)

(72) Inventor: Jean-Luc MEYRENAUD, Bobigny Cedex (FR)

(73) Assignee: VALEO VISION, Bobigny Cedex (FR)

(21) Appl. No.: 15/586,703

(22) Filed: May 4, 2017

(30) Foreign Application Priority Data
May 4, 2016 (FR) 16 54045

(51) Int. Cl. F21S 8/10; F21V 7/00; F21S 8/12; F21V 7/09; B60Q 1/06

(52) U.S. Cl. CPC F21S 48/1757; F21V 7/09; F21V 7/0025; B60Q 1/06; F21S 8/12; F21S 8/10; F21S 48/1388

(57) ABSTRACT

Lighting module for an automobile, comprising a reflector having at least two surface portions, at least one of the surface portions being movable, and at least two light sources, each light source being associated with one of the surface portions in order to generate a primary light beam by reflection of the light output from said source. The lighting module is configured for a surface portion to be movable and to have a movement which causes a variation in the coverage between the light beams generated by the lighting module.

The present invention belongs to the domain of light-emitting devices, and in particular to the domain of light-emitting modules included in such devices.

The term “light-emitting device” is understood as meaning any device able to emit light. For example, a vehicle headlamp or headlight, a flashlight, a light integrated into a vehicle interior, a courtesy light integrated into a seat in a railway carriage, a component of a television screen or else a high-intensity lamp included on a coastguard ship are examples of light-emitting devices. The term “vehicle” is understood as meaning any type of device able to move, such as an automobile, a van, a scooter, an airplane, a train or else a sledge.

The term “light-emitting module” is understood as meaning any sub-device of the light-emitting device from which light is emitted. The light-emitting module may thus comprise a light source.

A range of shapes and effects are particularly sought when light-emitting devices are designed, firstly for esthetic reasons, but also for reasons of size. In particular, light-emitting modules able to combine different illumination and signaling functions are especially sought.

The use of a single light-emitting module such as a high beam and a low beam is known. Up until now, however, various technological constraints have restricted the design of modules combining a greater range of functions. For example, it is particularly difficult to combine a daytime running lamp (DRL) with a low beam or a high beam.

Specifically, the lighting constraints imposed on low/high beams and daytime running lamps are very different. In particular, low/high beams must be able to generate a directional light beam having high-intensity in a given direction. Daytime running lamps, on the other hand, must have low directionality (isotropic illumination) and mid-level intensity.

There is thus a need for a light-emitting module able to combine various functions, some of which have very different constraints.

The present invention is intended to improve the situation.

To this end, a first aspect of the invention is aimed at a lighting module for an automobile, comprising a reflector having at least two surface portions, at least one of the surface portions being movable, and at least two light sources, each light source being associated with one of the surface portions in order to generate a primary light beam by reflection of the light output from said source;

characterized in that said at least one movable surface portion is able to be displaced:
to a first position such that the surface portions assume a first configuration in which the primary light beams are reflected in order to be superimposed in a first global beam having a maximum intensity greater than a first given threshold value;
to a second position such that the surface portions assume a second configuration in which the primary light beams are reflected in order to be superimposed in a second global beam having a maximum intensity lower than a second given threshold value;
   the first given threshold value being 10 times greater than the second given threshold value.

The term “surface portion” is understood as meaning any type of portion of any type of surface. A circular portion of a planar surface, a point on a parabolic surface, the whole of a hyperboloid surface or else a first sub-portion of a conical surface combined with a second sub-portion of the conical surface, are examples of surface portions.

The ability to move of the surface portion associated with a light source in particular makes it possible to modify focusing of the source in relation to the surface. The rays emitted by the source are therefore no longer reflected in a concentrated and intense beam, but in a beam with little directionality and reduced intensity.

In addition, the effect of taking account of the maximum intensity ensures that, according to the position of the movable surface portion, the beams do not exceed legal requirements. Moreover, an effect specific to the choice of this value is obtained in so far as said value is the best compromise between the complexity of the movement imposed on the surface portion, the required quality of the materials, especially for reflection and the sources, and legal requirements.

In addition to being able to reduce the size of the light-emitting device by combining, in a single light-emitting module, functions such as low/high beam and daytime running lamp, the module according to the invention comprises at least one surface portion the movement of which has a very sought-after esthetic.

According to one mode of embodiment, movement of the movable portion from the first position toward the second position is designed to shift the primary beam produced by the movable portion in relation to the primary beam produced by another portion of the reflector, in such a way as to reduce the coverage of the primary beams and the maximum intensity of the global beam produced by superimposing the primary beams. The reduction in coverage by a simple movement of the mobile portion enables the lighting module according to the invention to have a dual function, for example low/high beam and daytime running.

According to another mode of embodiment, movement of the movable portion from the first position toward the second position is designed to move a focus of said movable portion away from the position of the light source associated with the movable portion.

According to one mode of embodiment, the first position of the movable portion is a position in which the light source associated with the movable portion is disposed substantially in the focus of the movable portion.

According to another mode of embodiment, the second position of the movable portion is a position in which the light source associated with the movable portion is disposed substantially outside the focus of the movable portion.

Defocusing the source in relation to the movable surface portion in particular has the effect of scattering the reflected rays in several directions. The coverage of the primary beams is thus reduced, which reduces the maximum intensity of the global beam.

According to one mode of embodiment, the reflector comprises at least three movable surface portions, in particular four. According to this mode of embodiment, each portion is movable in relation to the light source associated therewith. Each light source is thus used in such a way that the resulting global beam corresponds to the desired function.

According to another mode of embodiment, the light sources are semiconductor light-emitting chips. According to a particular mode of embodiment, the emitting chips are electroluminescent diodes. Such chips have emission characteristics and a size which are particularly well-suited to the movable surface portions. Specifically, in order to use such movable surfaces, the sources must be compact and be able to emit high-intensity radiation.

According to one mode of embodiment, the light sources are formed by ends of light guides, other respective ends of the guides being connected to the emitting chips. The use of guides simplifies the design of the modules in so far as it is easier to position the ends of the guides in places which are not readily accessible such as the focuses of the surface portions.

According to one mode of embodiment, the module comprises at least three surface portions, in which:

at least one first portion, in particular two, is configured to generate a flat primary beam by reflection;

at least a second portion is configured to generate a range primary beam by reflection;

at least one third portion is configured to generate a primary beam having an oblique cut-off by reflection.

The term “flat primary beam” is understood as meaning any type of wide beam comprising a horizontal cut-off. The term “range primary beam” is understood as meaning any type of concentrated beam comprising a horizontal cut-off. The term “primary beam having an oblique cut-off” is understood as meaning any type of beam comprising an oblique cut-off. When a beam is projected against a screen, the zone included in the cut-off is not illuminated on the screen by the beam.

The global beam resulting from superimposing the abovementioned beams has the characteristics required to function as a low/high beam.

In particular, according to one mode of embodiment, the first, second and third portions are movable such as to be able to be displaced from the first to the second position.

According to this mode of embodiment, a first global beam produced by superimposing the flat, range and oblique primary beams, when the first, second and third portions are in the first position, is a beam of the regulatory low beam type.

Likewise, according to one mode of embodiment, the first, second and third portions are movable such as to be able to be displaced from the first to the second position. According to this mode of embodiment, a second global beam produced by superimposing the flat, range and oblique primary beams, when the first, second and third portions are in the second position, is a beam of the regulatory daytime lamp type.

Depending on the position of the movable portions, the global beams are thus regulatory lamps and can therefore be installed on automobiles.

According to another mode of embodiment, at least one surface portion is a complex surface. According to this mode of embodiment, the complex surface comprises a section having a first lower portion having a first focus arranged in such a way that light rays emitted from this first focus are returned below a predetermined line. The surface further comprises a second upper portion having a second focus, separate from the first focus, arranged in such a way that light rays emitted from this second focus are returned below said predetermined line.

The term “predetermined line” is understood as meaning any type of line, for example substantially horizontal, which is visible when the beam generated by the module is projected onto a screen. For example, the predetermined line may correspond to a regulatory requirement in terms of separation between an upper portion and a lower portion of the beam emitted by a high/low or daytime lamp.

According to one mode of embodiment, the light source associated with the complex surface portion is disposed at the barycenter of said first and second focuses, the barycenter constituting the focus of the surface portion. The flat, range and/or oblique primary beams can be easily reflected on a complex surface of this kind.

According to another mode of embodiment, at least one surface portion has a section with a parabolic profile. The use of parabolic surfaces of this kind simplifies the design and manufacture of the lighting modules.

The invention covers any type of combination of one or more complex surfaces with one or more parabolic surfaces.

According to one mode of embodiment, the lighting module comprises a device for controlling the electrical supply of the light sources, designed to reduce the electrical power provided to at least one light source when the movable portion is displaced from the first position toward the second position. Movement of the movable surface portion is thus combined with a variation in the intensity such that the global beam emitted responds perfectly to the regulatory requirements.

Other features and advantages of the invention will become apparent on examining the detailed description that follows, and the appended drawings in which:

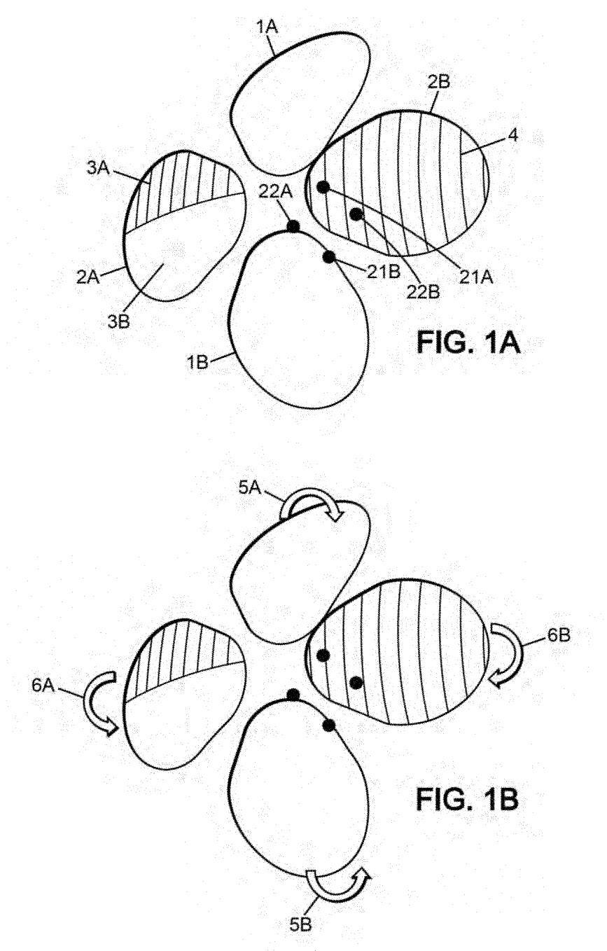

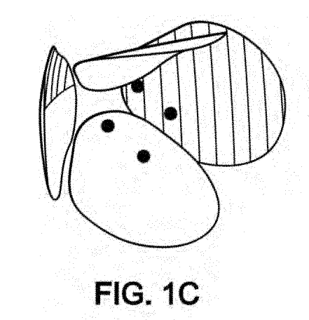

FIG. 1A illustrates the lighting module according to a mode of embodiment of the invention, in the first position;

FIG. 1B illustrates movement of the lighting module according to a mode of embodiment of the invention from the first position to the second position;

FIG. 1C illustrates the lighting module according to a mode of embodiment of the invention, in the second position;

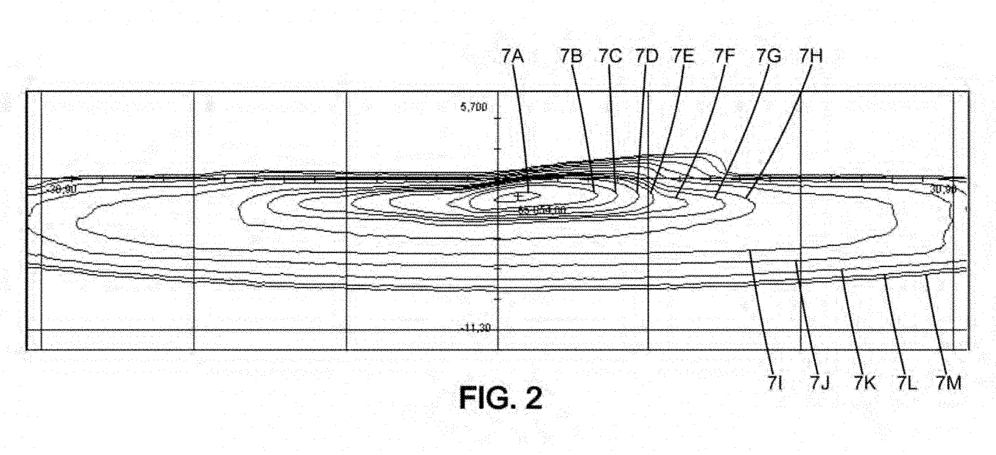

FIG. 2 is an illumination diagram of the lighting module according to a mode of embodiment of the invention, in the first position;

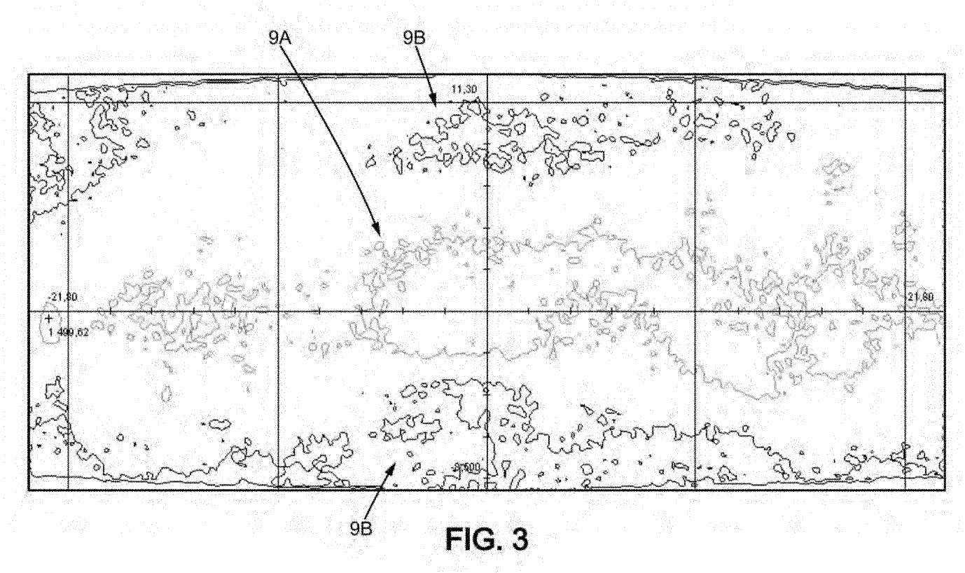

FIG. 3 is an illumination diagram of the lighting module according to a mode of embodiment of the invention, in the second position;

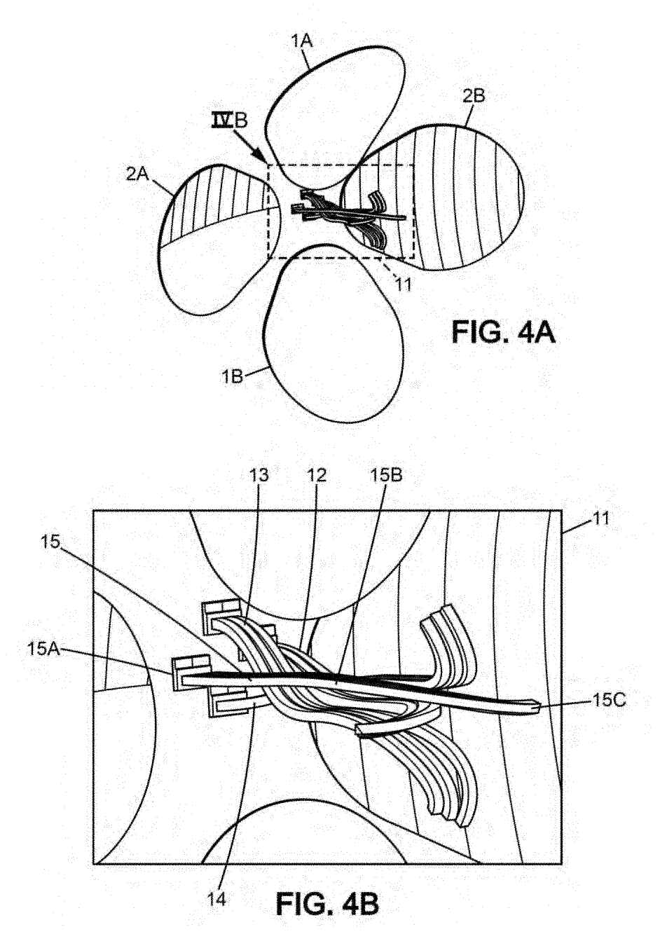

FIG. 4A illustrates the lighting module according to another mode of embodiment of the invention;

FIG. 4B illustrates the detail of the guides of the lighting module according to the other mode of embodiment of the invention; and

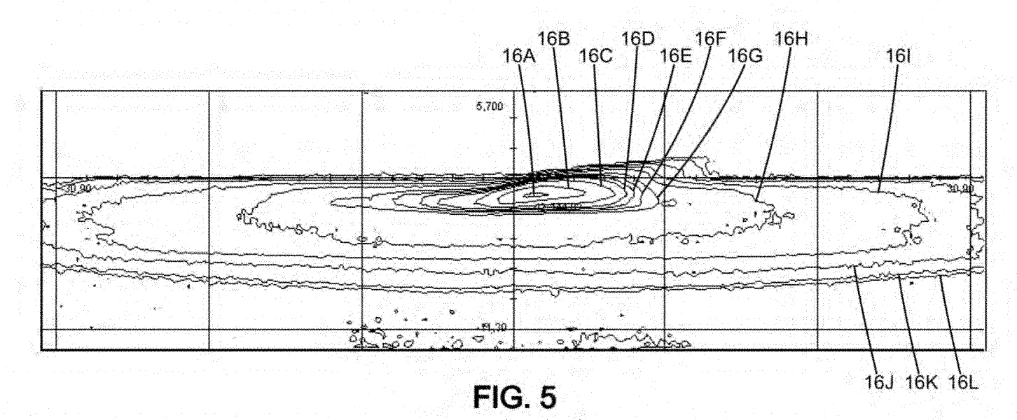

FIG. 5 is an illumination diagram of the lighting module according to a mode of embodiment of the invention, in the first position and with the light guides.

The light-emitting module according to the invention is described hereinafter in a non-limiting manner in its application to a light-emitting device in an automobile. Other applications such as a device according to the invention being used as a lamp or interior decor in an automobile, as a Christmas wreath, or else as a road sign may equally be envisioned.

The module is configured to implement one or more photometric functions, for example.

A photometric function is a function of illumination and/or signaling that is visible to the human eye, for example. It will be noted that these photometric functions may be subject to one or more regulations establishing requirements in terms of colorimetry, intensity, spatial distribution in accordance with a grid referred to as a photometric grid, or else ranges of visibility of the light emitted.

A light-emitting device comprising the module according to the invention is an illumination device, for example, and constitutes a vehicle lamp or headlight. It is then configured to implement one or more photometric functions selected, for example, from among a function as a low beam light referred to as “low-beam function” (UNECE regulations 87 and 123), a function as a position light (UNECE regulation 007), a function as a high beam light referred to as “high-beam function” (UNECE regulation 123), and a fog function (UNECE regulations 019 and 038).

Alternatively, the device is a signaling device intended to be arranged at the front or at the rear of the vehicle.

When the device is intended to be arranged at the front, these photometric functions include a function for indicating a change of direction (UNECE regulation 006), a daytime illumination function known by the English acronym DRL (UNECE regulation 087) for “Daytime Running Light”, and a front light signature function.

When the device is intended to be arranged at the rear, these photometric functions include a reversing indication function (UNECE regulation 023), a stop function (UNECE regulation 007), a fog function (UNECE regulations 019 and 038), a function for indicating a change of direction (UNECE regulation 006), and a rear light signature function.

Alternatively, the device is provided for illuminating a passenger compartment and is then intended to emit light mainly within the passenger compartment.

FIG. 1A depicts a light-emitting module according to a mode of embodiment of the invention, in a first position.

The module comprises four surface portions 1A, 1B, 2A and 2B. According to this mode of embodiment, the four portions are movable. The surface portions are made of a material suitable for reflecting the rays emitted by the sources, such as materials used for manufacturing a mirror.

According to one mode of embodiment, each of the surface portions is configured to generate a specific beam by reflection, for example:
the portions 1A and 1B may be configured to generate a flat primary beam by reflection;
the portion 2B may be configured to generate a range primary beam by reflection. In order to achieve this, the portion 2B may have a shape and/or a coating 4 specifically designed to generate a concentrated beam comprising a horizontal cut-off,
the portion 2A may be configured to generate a primary beam having an oblique cut-off by reflection. In order to achieve this, the portion 2A comprises an upper portion 3A and a lower portion 3B. These portions, taken alone or in combination, have a shape and/or a coating specifically designed to generate a concentrated beam having a horizontal cut-off.

According to one mode of embodiment, at least one surface portion is a complex surface. The complex surface comprises a section having a first lower portion having a first focus arranged in such a way that light rays emitted from this first focus are returned below a predetermined line. The complex surface further comprises a second upper portion having a second focus, separate from the first focus, arranged in such a way that light rays emitted from this second focus are returned below said predetermined line.

In particular, the light source associated with the complex surface portion may be disposed at the barycenter of said first and second focuses, the barycenter constituting the focus of the surface portion.

At least one surface portion may equally have a section with a parabolic profile.

The module further comprises four light sources 21A, 21B, 22A and 22B, each light source being respectively associated with the surface portions 1A, 1B, 2A and 2B in order to generate a primary light beam by reflection of the light output from this source. The light sources are described in detail hereinafter with reference to FIGS. 4A and 4B.

In the first position, the surface portions are in a first configuration in relation to the sources, in which the primary light beams are reflected in order to be superimposed in a first global beam having a maximum intensity greater than a first given threshold value.

Thus, for example, the source 21A emits light rays on the surface portion 1A. These rays are reflected by the surface portion in such a way that the resulting reflected rays are superimposed. As explained above, complex or parabolic surface portions having an adequate reflection index are able to generate such superimposition. The reflection index may be variable.

FIG. 1B illustrates a movement of the movable surface portions in accordance with a mode of embodiment. Movements from the first position toward a second position of the surface portions 1A, 1B, 2A and 2B are respectively represented by the arrows 5A, 5B, 6A and 6B.

FIG. 1B illustrates a movement of the four surface portions. However, it is equally possible for only a single surface portion to be movable. In this situation in particular, the lighting module may comprise a device for controlling the electrical supply of the light sources, designed to reduce the electrical power provided to at least one light source when the movable portion is displaced from the first position toward the second position.

All other combinations (movement of portions 1A and 1B, or 2A and 2B, or 1A, 2A and 2B, etc.) of surface portion movement are equally possible.

In the second position, the surface portions assume a second configuration in which the primary light beams are reflected in order to be superimposed in a second global beam having a maximum intensity lower than a second given threshold value.

The phrase “the surface portions assume a second configuration” is understood as meaning that at least one surface portion has undertaken a movement which results in the primary light beams being reflected so as to be superimposed in the second global beam. This does not necessarily mean that each surface portion must undertake a movement. Specifically, it is possible to cause only a single surface portion to move in order to modify the optical effects of superimposition (typically by defocusing the source of the movable surface portion) and thus change the value of the maximum intensity. As explained above, it is equally possible to cause the electrical power provided to at least one light source to be varied.

The first given threshold value is at least 10 times greater than the second given threshold value. The first value is 30 times greater than the second value, for example.

The movement of said at least one movable portion from the first position toward the second position is designed to shift the primary beam produced by this movable portion in relation to the primary beam produced by another portion of the reflector. In particular, this movement is configured so that the coverage of these primary beams and the maximum intensity of the global beam produced by superimposing these primary beams are reduced.

To be more precise, the movement of the movable portion from the first position toward the second position is designed to move a focus of said movable portion away from the position of the light source associated with the movable portion. Typically, the first position of the movable portion is a position in which the light source associated with the movable portion is disposed substantially in the focus of the movable portion and the second position of the movable portion is a position in which the light source associated with the movable portion is disposed substantially outside the focus of the movable portion.

This defocusing of the source in relation to a reflective surface portion includes a shift of the source in relation to the focus of the surface portion. Specifically, when the source is moved away from the focus, the light rays reflected no longer converge. The effect of superimposition of the rays is therefore strongly reduced and the maximum intensity varies as a result.

FIG. 1C illustrates the lighting module in the second position, according to a mode of embodiment. According to this mode of embodiment, all the portions have undertaken a movement.

The general shape of the lighting module may be similar to the shape of a flower comprising four petals. The movements may then be similar to closing (or folding) of the petals of the flower.

FIG. 2 is an illumination diagram of the lighting module according to a mode of embodiment of the invention, in the first position. The curves 7A to 7M indicate the variations in space of the intensity of the global beam generated. This diagram may be seen as a screen on which the beam is projected.

In the first position, the global beam is concentrated around a central point located in the center of the ellipsoid formed by the curve 7A, which corresponds to the highest intensity. The beam is indeed located under a horizontal line, as required by the regulations in force. Moreover, a slight oblique shift or “kink”, is present in the upper portion of the horizontal line, as also required by the regulations in force. This kink is typically produced by the portion 2A which may be configured in order to generate a primary beam having an oblique cut-off by reflection.

FIG. 3 is an illumination diagram of the lighting module according to a mode of embodiment of the invention, in the second position. The curves 9A and 9B indicate the variations in space of the intensity of the global beam generated. This diagram may also be seen as a screen on which the beam is projected.

The curve 9A (light gray curve) represents the highest intensity and the curve 9B (black curve) represents a lower intensity. However, the intensities vary very little between the two curves.

Specifically, in the second position, the global beam is far more diffuse than in the first position. As mentioned above, this diffuse effect of the global beam is typically obtained by defocusing the sources in relation to the respective focuses of the surface portions.

The diagram depicted in FIG. 3 thus illustrates the diffuse global beam generated in the second position.

FIGS. 4A and 4B illustrate a possible mode of embodiment for the light sources. According to this mode of embodiment, the light sources are formed by ends of light guides 12, 13, 14 and 15, other respective ends of the guides being connected to the emitting chips.

The light guides may comprise any type of material able to guide light. For example, the guides may include any type of material comprising silicon, such as a siloxane or a polysiloxane. The guide may be rigid or flexible.

FIG. 4B is a zoom of the portion 11 in FIG. 4A. The light guide 15 will now be described in detail with reference to FIG. 4B.

The light guide includes an end 15C configured as an output for light guided in a body 15B of the guide 15. The guide has a linear, planar, tubular or else rectangular shape. The other end 15A of the guide is typically connected to a semiconductor light-emitting chip.

These chips comprise for example light-emitting diodes (LEDs).

The light generated from the end 15A is therefore guided through the body 15B so as to exit at the level of the end 15C. As explained above, in the first position, the end 15C may be placed at the level of the focus of the corresponding surface portion, the portion 2B in the case of the guide 15.

According to a preferred mode of embodiment, the sources are fixed in relation to the lighting module. As a variant, the sources equally have a movement, for example during the passage from the first position to the second position of said at least one surface portion.

The light sources may equally be simple sources without a light guide. For example, the light sources may simply be the light-emitting chips.

FIG. 5 is an illumination diagram of the lighting module according to a mode of embodiment of the invention, in the first position and with the light guides. It will be pointed out that the diagrams given in FIGS. 2 and 3 correspond to situations in which the light sources are simple sources, such as emitting chips. The curves 16A to 16L indicate the variations in space of the intensity of the global beam generated. This diagram may be seen as a screen on which the beam is projected.

In the first position, the global beam is concentrated around a central point located in the center of the ellipsoid formed by the curve 16A, which corresponds to the highest intensity. In contrast to FIG. 2, the intensity curves have more diffuse boundaries, especially in the zones further away from the central mark delimited by the curve 16A of maximum intensity. The curves 16H to 16L thus have more diffuse boundaries.

The present invention is not limited to the forms of embodiment described above by way of example; it also extends to other variants.

A mode of embodiment was thus described above in which the light-emitting module was shaped substantially like a flower. However, all types of shapes in all types of directions are covered by the present invention. For example, two surface portions having a rectangular shape or else eight surface portions having a triangular shape are also covered.

Furthermore, a specific number of light sources and of surface portions was described above. Of course, the number of sources/portions is not limited to these examples, and the invention covers all possible combinations of source and portions.

1: Lighting module for an automobile, comprising a reflector having at least two surface portions, at least one of the surface portions being movable, and at least two light sources, each light source being associated with one of the surface portions in order to generate a primary light beam by reflection of the light output from said source;
wherein said at least one movable surface portion is able to be displaced:
to a first position such that the surface portions assume a first configuration in which the primary light beams are reflected in order to be superimposed in a first global beam having a maximum intensity greater than a first given threshold value;
to a second position such that the surface portions assume a second configuration in which the primary light beams are reflected in order to be superimposed in a second global beam having a maximum intensity lower than a second given threshold value;
the first given threshold value being 10 times greater than the second given threshold value.

2: Lighting module according to claim 1, in which movement of the movable portion from the first position toward the second position is designed to shift the primary beam produced by the movable portion in relation to the primary beam produced by another portion of the reflector, in such a way as to reduce the coverage of the primary beams and the maximum intensity of the global beam produced by superimposing the primary beams.

3: Lighting module according to claim 1, wherein movement of the movable portion from the first position toward the second position is designed to move a focus of said movable portion away from the position of the light source associated with the movable portion.

4: Lighting module according to claim 1, wherein the first position of the movable portion is a position in which the light source associated with the movable portion is disposed substantially in the focus of the movable portion.

5: Lighting module according to claim 1, wherein the second position of the movable portion is a position in which the light source associated with the movable portion is disposed substantially outside the focus of the movable portion.

6: Lighting module according to claim 1, wherein the reflector comprises at least three movable surface portions, in particular four, and in which each portion is movable in relation to the light source associated therewith.

7: Lighting module according to claim 1, wherein the light sources are semiconductor light-emitting chips.

8: Lighting module according to claim 7, wherein the light sources are formed by ends of light guides, other respective ends of the guides being connected to the emitting chips.

9: Lighting module according to claim 1, comprising at least three surface portions, wherein: at least one first portion, in particular two, is configured to generate a flat primary beam by reflection; at least a second portion is configured to generate a range primary beam by reflection; at least one third portion is configured to generate a primary beam having an oblique cut-off by reflection.

10: Lighting module according to claim 9, wherein the first, second and third portions are movable such as to be able to be displaced from the first to the second position, and wherein a first global beam produced by superimposing the flat, range and oblique primary beams, when the first, second and third portions are in the first position, is a beam of the regulatory low beam type.

11: Lighting module according to claim 10, wherein the first, second and third portions are movable such as to be able to be displaced from the first to the second position, and in which a second global beam produced by superimposing the flat, range and oblique primary beams, when the first, second and third portions are in the second position, is a beam of the regulatory daytime lamp type.

12: Lighting module according to claim 1, wherein at least one surface portion is a complex surface, said complex surface comprising a section having a first lower portion having a first focus arranged in such a way that light rays emitted from this first focus are returned below a predetermined line, and
comprising a second upper portion having a second focus, separate from the first focus, arranged in such a way that light rays emitted from this second focus are returned below said predetermined line.

13: Lighting module according to claim 12, wherein the light source associated with the complex surface portion is disposed at the barycenter of said first and second focuses, the barycenter constituting the focus of the surface portion.

14: Lighting module according to claim 1, wherein at least one surface portion has a section with a parabolic profile.

15: Lighting module according to claim 1, wherein the lighting module comprises a device for controlling the electrical supply of the light sources, designed to reduce the electrical power provided to at least one light source when the movable portion is displaced from the first position toward the second position.

16: Lighting module according to claim 2, wherein movement of the movable portion from the first position toward the second position is designed to move a focus of said movable portion away from the position of the light source associated with the movable portion.

17: Lighting module according to claim 3, wherein the first position of the movable portion is a position in which the light source associated with the movable portion is disposed substantially in the focus of the movable portion.

18: Lighting module according to claim 4, wherein the second position of the movable portion is a position in which the light source associated with the movable portion is disposed substantially outside the focus of the movable portion.

19: Lighting module according to claim 5, wherein the reflector comprises at least three movable surface portions, in particular four, and in which each portion is movable in relation to the light source associated therewith.

20: Lighting module according claim 6, wherein the light sources are semiconductor light-emitting chips.
